(19) United States
(12) Patent Application Publication
(10) Pub. No.: US 2015/0195391 A1
(43) Pub. Date: Jul. 9, 2015

(54) Portable data processing apparatus and peripheral apparatus

(71) Applicant: Aava Mobile Oy, Oulu (FI)

(72) Inventors: Tero NYGARD, OULU (FI); Mika SIPOLA, OULU (FI); Piotr FRASUNKIEWICZ, OULU (FI)

(73) Assignee: Aava Mobile Oy, Oulu (FI)

(21) Appl. No.: 14/151,105

(22) Filed: Jan. 9, 2014

(51) Int. Cl. H04M 1/02; G06F 3/041

(52) U.S. Cl. CPC H04M 1/0266; G06F 3/041; H04M 1/0262

(57) ABSTRACT

A portable data processing apparatus and its peripheral apparatus are disclosed. A battery compartment includes an electrical connector communicatively coupled with one or more processors, and the battery compartment and an electrical connector are adapted and dimensioned such that a detachable cover is replaceable with a peripheral apparatus, which, when installed in place, functions as the cover of the battery compartment, and the one or more processors become communicatively coupled through the electrical connector with an electrical counterpart connector of the peripheral apparatus.

### FIELD

The invention relates to a portable data processing apparatus, a peripheral apparatus for a portable data processing apparatus, and a combination of a portable data processing apparatus and a peripheral apparatus.

### BACKGROUND

Portable data processing apparatus and their peripherals are well-known in the art. However, their usability calls for further sophistication.

### BRIEF DESCRIPTION

The present invention seeks to provide an improved portable data processing apparatus, an improved peripheral apparatus for a portable data processing apparatus, and an improved combination of a portable data processing apparatus and a peripheral apparatus.

According to an aspect of the present invention, there is provided a portable data processing apparatus comprising a touch screen, one or more processors communicatively coupled with the touch screen, a housing holding the touch screen and encasing the one or more processors, a battery compartment within the housing, and a detachable cover for the battery compartment, wherein the battery compartment comprises an electrical connector communicatively coupled with the one or more processors, and the battery compartment and the electrical connector are adapted and dimensioned such that the detachable cover is replaceable with a peripheral apparatus, which, when installed in place, functions as the cover of the battery compartment, and the one or more processors become communicatively coupled through the electrical connector with an electrical counterpart connector of the peripheral apparatus.

According to another aspect of the present invention, there is provided a peripheral apparatus for a portable data processing apparatus, comprising an electronics module, a unit housing encasing the electronics module, an electrical counterpart connector communicatively coupled with the electronics module, wherein the peripheral apparatus and the electrical counterpart connector are adapted and dimensioned such that a cover of a battery compartment of the portable data processing apparatus is replaceable with the peripheral apparatus, which, when installed in place, functions as the cover of the battery compartment, and the electrical counterpart connector of the peripheral apparatus is communicatively coupled with one or more processors of the portable data processing apparatus through an electrical connector of the portable data processing apparatus.

According to another aspect of the present invention, there is provided a combination of a portable data processing apparatus and a peripheral apparatus, the portable data processing apparatus comprising a touch screen, one or more processors communicatively coupled with the touch screen, a housing holding the display and encasing the one or more processors, a battery compartment within the housing, a detachable cover for the battery compartment mechanically couplable with the housing, wherein the battery compartment comprises an electrical connector communicatively coupled with the one or more processors, and the battery compartment and the electrical connector are adapted and dimensioned such that the detachable cover is replaceable with the peripheral apparatus, which, when installed in place, functions as the cover of the battery compartment, and the one or more processors become communicatively coupled through the electrical connector with an electrical counterpart connector of the peripheral apparatus, the peripheral apparatus comprising an electronics module, a unit housing encasing the electronics module, an electrical counterpart connector communicatively coupled with the electronics module, wherein the peripheral apparatus and the electrical counterpart connector are adapted and dimensioned such that the cover of the battery compartment is replaceable with the peripheral apparatus, which, when installed in place, functions as the cover of the battery compartment, and the electrical counterpart connector of the peripheral apparatus is communicatively coupled with the one or more processors through the electrical connector.

### LIST OF DRAWINGS

Example embodiments of the present invention are described below, by way of example only, with reference to the accompanying drawings, in which

FIG. 1 illustrates example embodiments of a portable data processing apparatus and a peripheral apparatus;

FIGS. 2, 3, 4 and 5 illustrate further example embodiments of the portable data processing apparatus;

FIG. 6 illustrates a further example embodiment of the peripheral apparatus;

FIG. 7 illustrates an example embodiment of fasteners attaching the peripheral apparatus to the portable data processing apparatus;

FIG. 8 illustrates an example embodiment of an electrical connector of the portable data processing apparatus; and

FIG. 9 illustrates further example embodiments of the peripheral apparatus attached to the portable data processing apparatus.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

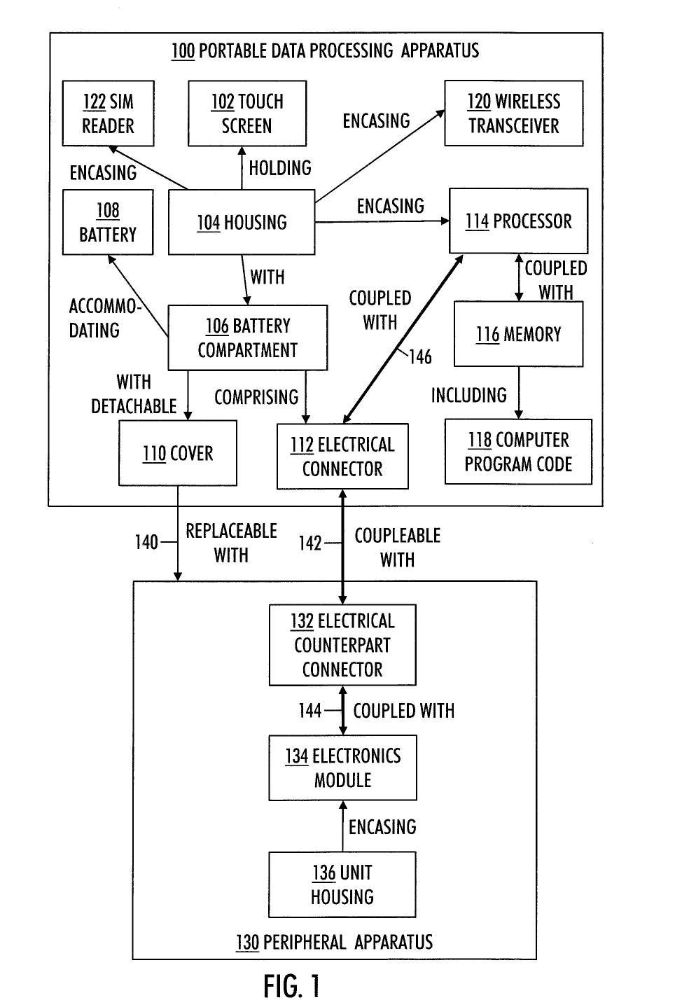

FIG. 1 illustrates example embodiments of a portable data processing apparatus 100 and a peripheral apparatus 130 in a form of a parts list.

The portable data processing apparatus 100 comprises a touch screen 102, one or more processors 114 communicatively coupled with the touch screen 102, a housing 104 holding the touch screen 102 and encasing the one or more processors 114, a battery compartment 106 within the housing 104, and a detachable cover 110 for the battery compartment 106.

In an example embodiment, the portable data processing apparatus 100 is a tablet computer. In another example embodiment, the portable data processing apparatus 100 is a phablet.

In an example embodiment, the touch screen 102 is a multi-touch display.

In an example embodiment, the portable data processing apparatus 100 is a general-purpose mobile computing device. In an example embodiment, the portable data processing apparatus 100 is a general-purpose off-the-shelf computing device, as opposed to a purpose-build proprietary equipment, whereby research & development costs will be lower as only the special-purpose software (and not the hardware) needs to be designed, implemented and tested.

In an example embodiment, the portable data processing apparatus 100 employs a suitable operating system such as iOS, Android, or Windows, for example.

In a further example embodiment, the portable data processing apparatus 100 is a portable data processing apparatus comprising a wireless transceiver 120 capable of communicating with other devices, with or without a separate telecommunications network infrastructure (such as base stations, access points etc.).

In an example embodiment, the wireless transceiver 120 may be interoperable with various wireless standard/non-standard/proprietary communication networks such as any mobile phone network, regardless of the generation (such as 2G, 3G, 4G, beyond 4G, etc.) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), and other radio systems (in their present forms and/or in their evolution forms), such as WLAN (Wireless Local Area Network) based on IEEE (Institute of Electrical and Electronics Engineers) 802.11 standard or its evolution versions (IEEE 802.11ac etc.), WiMAX (Worldwide Interoperability for Microwave Access, or Wi-Fi, for example.

In an example embodiment, the wireless transceiver 120, while communicating with a mobile phone network, may require a subscriber identity module (SIM), which may be an integrated circuit storing subscriber data, which is network-specific information used to authenticate and identify subscribers on the cellular network. The subscriber identity module may be embedded into a removable SIM card, on a mini-SIM card, for example. Furthermore, the portable data processing apparatus 100 may include a SIM card reader 122, for example. Besides being implemented on a SIM card, the subscriber identity module may be implemented with other techniques as well, such as a virtual/embedded SIM.

In further example embodiments, the portable data processing apparatus 100 may comprise a battery 108 accommodated by the battery compartment 106, a memory 116 coupled with the one or more processors 114, and computer program code 118 included in the memory 116.

The peripheral apparatus 130 for the portable data processing apparatus 100 comprises an electronics module 134 and a unit housing 136 encasing the electronics module 134.

In an example embodiment, the peripheral apparatus 130 is a device that may become connected to the portable data processing apparatus 100, but not becoming an inseparable part of it. The peripheral apparatus 130 may expand the capabilities of the portable data processing apparatus 100. The peripheral apparatus 130 may be partially or completely dependent on the portable data processing apparatus 100.

In an example embodiment, the peripheral apparatus 130 implements at least one of the following functions for the portable data processing apparatus 100: input data to the portable data processing apparatus 100, and/or output data from the portable data processing apparatus 100.

In an example embodiment, the peripheral apparatus 130 is a device external to the case 104 of the portable data processing apparatus 100. In an example embodiment, the peripheral apparatus 130 is an external peripheral apparatus as opposed to an internal peripheral apparatus located inside the housing 104 of the portable data processing apparatus 100.

In an example embodiment, the peripheral apparatus 130 is an accessory which replaces the default battery cover 110 and enables customer specific additional features to the portable data processing apparatus 100.

As was explained earlier, while the portable data processing apparatus 100 may be a general-purpose mobile computing device, the customer specific additional hardware features may be implemented with the peripheral apparatus 130. Research & development costs will be lower as the special-purpose hardware may be implemented onto the peripheral apparatus 130, and the portable data processing apparatus 100 only needs special-purpose software 118 supporting the peripheral apparatus 130.

In an example embodiment, the peripheral apparatus 130 may contain electrical and/or mechanical extra features to make the portable data processing apparatus 100 suitable for various specific use cases. An electrical interface may comprise a communication interface and a power supply interface. A mechanical interface may be implemented by dimensioning the battery compartment 106 and its cover 110 appropriately.

In an example embodiment, use cases for the combination of the portable data processing apparatus 100 and its peripheral apparatus 130 include at least one of the following: a payment terminal, device mounting, a charging accessory, an additional power supply, a bar code reader, additional sensors (such as GPS or other satellite navigation receiver, acceleration sensor), and/or additional input devices.

Let us next study in more detail the features that enable the flexible configuration of the portable data processing apparatus 100 with the changeable peripheral apparatus 130.

The battery compartment 106 of the portable data processing apparatus 100 comprises an electrical connector 112 communicatively coupled 146 with the one or more processors 114. The battery compartment 106 and the electrical connector 112 are adapted and dimensioned such that the detachable cover 110 is replaceable 140 with the peripheral apparatus 130. The peripheral apparatus 130 comprises an electrical counterpart connector 132 communicatively coupled 144 with the electronics module 134.

The peripheral apparatus 130, when installed in place, functions as the cover 110 of the battery compartment 106, and the one or more processors 114 become communicatively coupled 142, 146 through the electrical connector 112 with the electrical counterpart connector 132 of the peripheral apparatus 130.

The peripheral apparatus 130 and the electrical counterpart connector 132 are adapted and dimensioned such that the cover 110 of the battery compartment 106 of the portable data processing apparatus 100 is replaceable 140 with the peripheral apparatus 130. The electrical counterpart connector 132 of the peripheral apparatus 130 is communicatively 142, 146 coupled with one or more processors 114 of the portable data processing apparatus 100 through the electrical connector 112 of the portable data processing apparatus 100.

As shown in FIG. 1, the electronics module 134 of the peripheral apparatus 130 becomes communicatively coupled 144, 142, 146 with the one or more processors 114 of the portable data processing apparatus 100. Consequently, the computer program code 118 supporting the operation of the peripheral apparatus 130 may be run on the one or more processors 114. The computer program code 118 supporting the peripheral apparatus 130 may be a part of the operating system resident in the memory 116 of the portable data processing apparatus 100. Alternatively or additionally, the computer program code 118 supporting the peripheral apparatus 130 may be brought into the portable data processing apparatus 100, through the electrical connector 112, with the wireless transceiver 120, or by importing it to the memory 116 through some other interface not shown in FIG. 1.

In an example embodiment, the portable data processing apparatus 100 is an Inari Tablet designed by the applicant, Aava Mobile, and the peripheral apparatus 130 is an Inari Tablet Smart Back.

It should be noted that while FIG. 1 illustrates various embodiments of apparatuses, it is only a simplified block diagram that only show some structures and functional entities. The connections shown in these Figures are logical connections; the actual physical connections may be different. Interfaces between the various elements may be implemented with suitable interface technologies, such as a message interface, a method interface, a sub-routine call interface, a block interface, or any hardware/software means enabling communication between functional sub-units. It is apparent to a person skilled in the art that the described apparatuses 100, 130 may also comprise other functions and structures. It should be appreciated that details of some functions, structures, and the protocols used for communication are irrelevant to the actual invention. Therefore, they need not be discussed in more detail here.

Now that the basic combination of the portable data processing apparatus 100 and the peripheral apparatus 130 is described, we may proceed in describing further example embodiments revealing further technical details and mechanical implementation details.

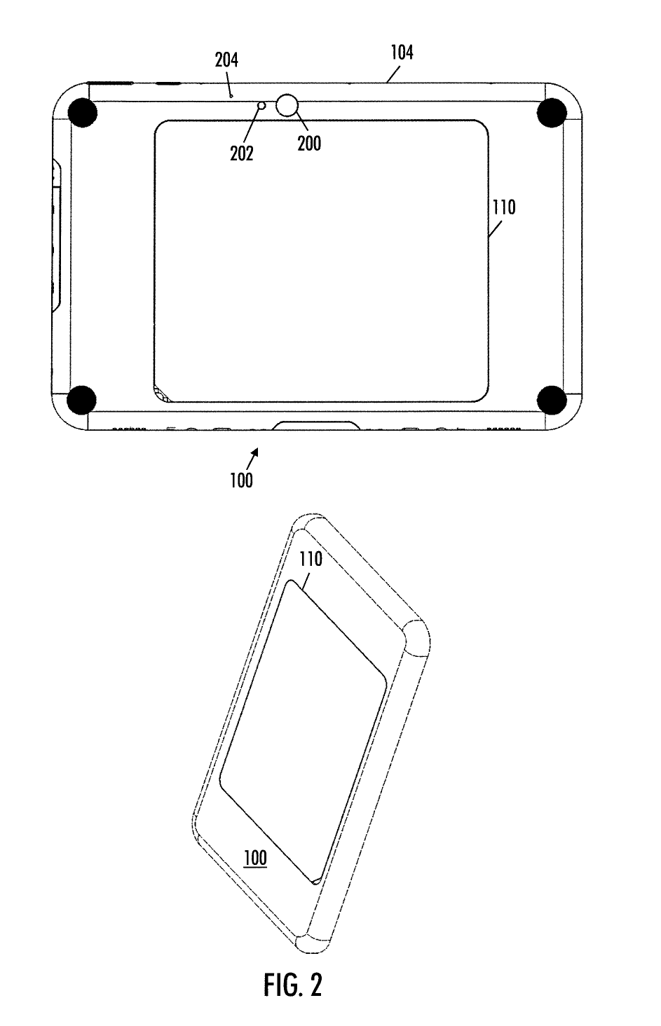

FIG. 2 illustrates an example embodiment of the portable data processing apparatus 100, viewed from the back and from the side. The housing 104 is shown together with the battery compartment cover 110. As was explained earlier, the portable data processing apparatus 100 may comprise also other parts not explained earlier, such as a camera 200, flashlight 202 and microphone 204. As can be seen in FIG. 2, the battery compartment cover 110 may only cover a portion of the backside of the housing 104.

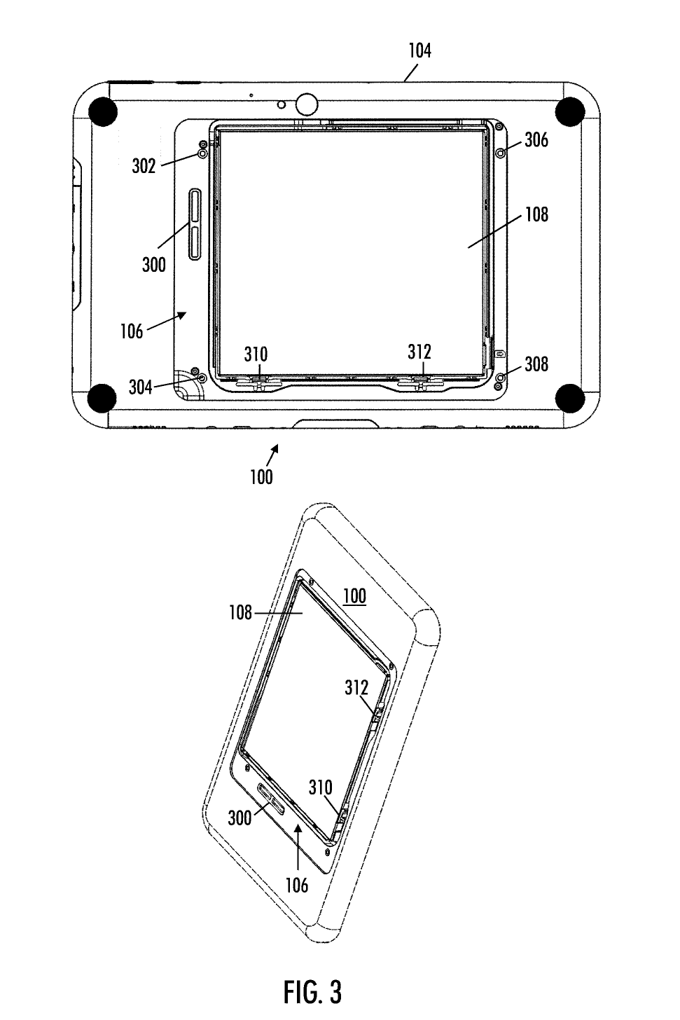

FIG. 3 illustrates an example embodiment of the portable data processing apparatus 100 with the battery compartment cover 110 removed, viewed from the back and from the side. The battery 108 is in place, embedded into a recess of the battery compartment 106.

In an example embodiment, the electrical connector 112 is protected by a detachable shield 300, which is removed before the peripheral apparatus 130 is installed in place. The detachable shield 300 may be made of suitable material such as elastic or plastic material. The detachable shield 300 may protect the electrical connector 112 from moisture, dust and/or mechanical impacts.

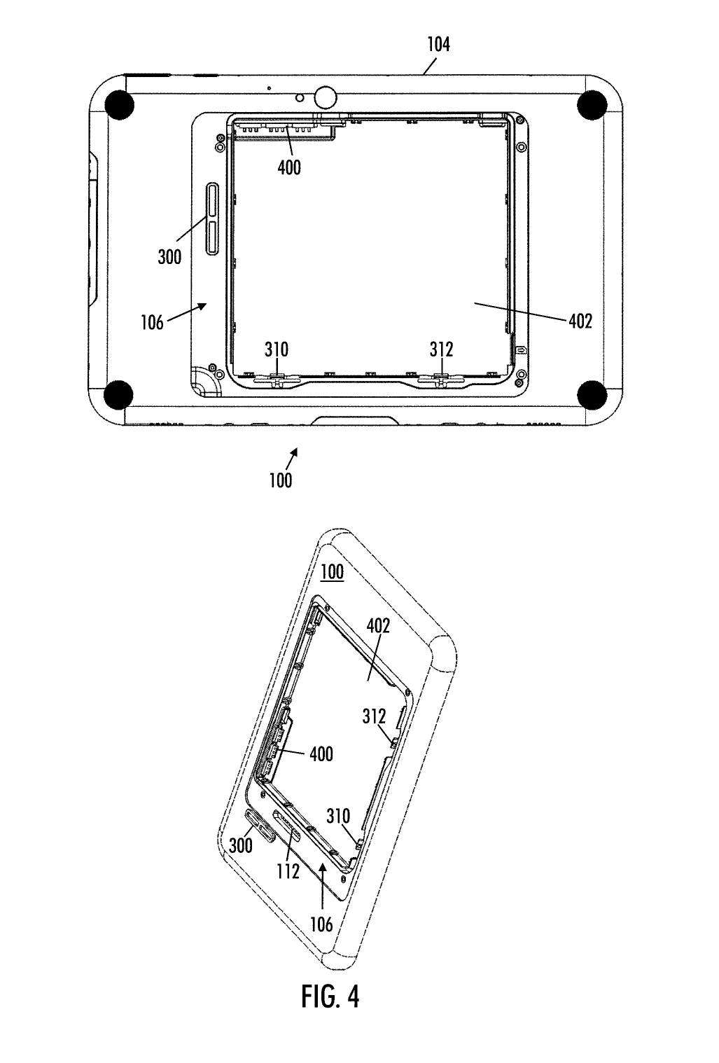

FIG. 4 illustrates an example embodiment of the portable data processing apparatus 100 with the battery compartment cover 110, battery 108 and detachable shield 300 removed, viewed from the back and from the side. The recess 402 of the battery compartment 106 capable of accommodating the battery 108 is now visible. Also an electrical connector 400 for the battery 108 is shown.

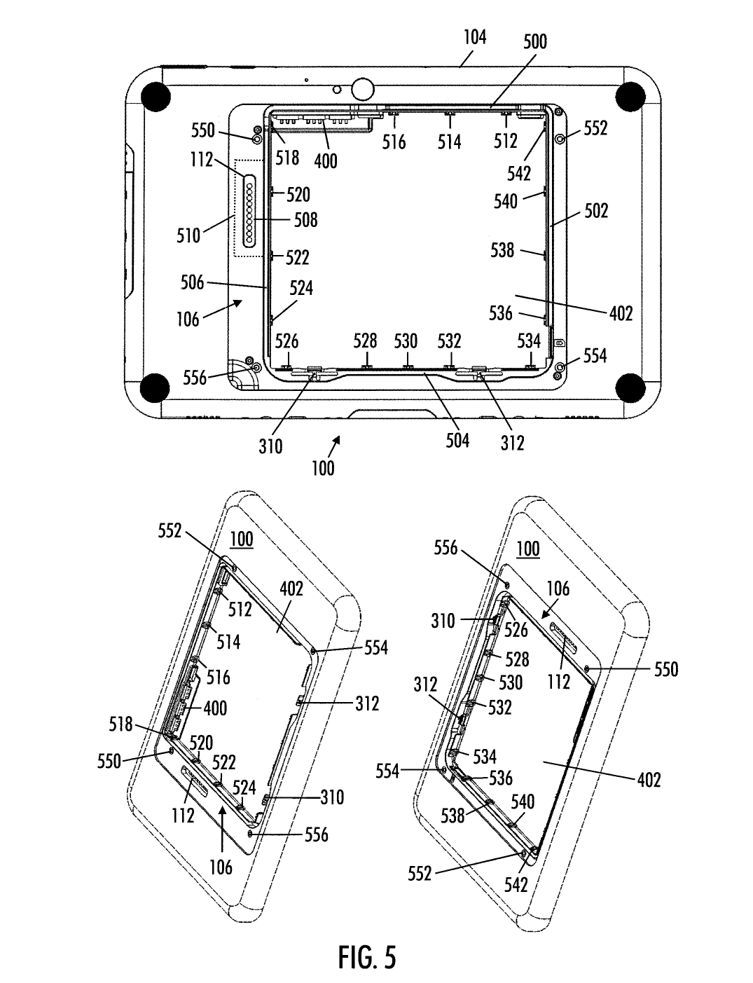

FIG. 5 illustrates further example embodiments of the portable data processing apparatus 100, viewed from the back and from two opposite sides.

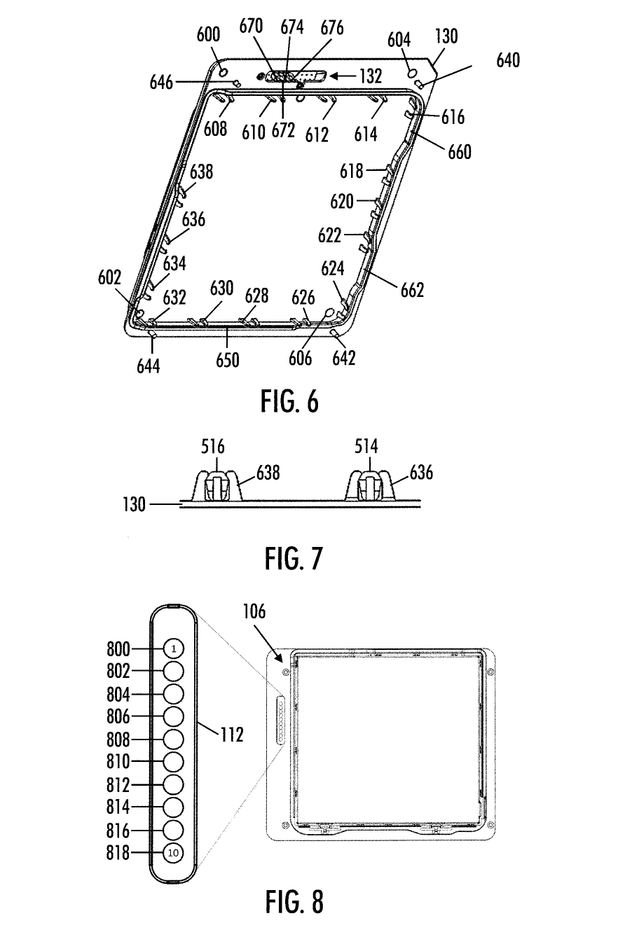

In an example embodiment, the battery compartment 106 comprises a compartment groove 500, 502, 504, 506, 510 capable of accommodating a compartment gasket 650 (shown in FIG. 6) of either the detachable cover 110 or the peripheral apparatus 130 to also protect the electrical connector 112 from at least one of moisture and dust, when either the detachable cover 110 or the peripheral apparatus 130 is installed in place. In FIG. 5, the compartment groove encircles the battery compartment 106 around its four sides 500, 502, 504 and 506, and, furthermore, it extends to enclose the electrical connector 112 as illustrated with the dotted line 510.

In an alternative example embodiment, the electrical connector 112 comprises a connector groove 508 capable of accommodating a connector gasket of either the detachable cover 110 or the peripheral apparatus 130 to protect the electrical connector 112 from at least one of moisture and dust, when either the detachable cover 110 or the peripheral apparatus 130 is installed in place. As illustrated in FIG. 5, the connector groove 508 may be implemented with a recessed electrical connector 112. This alternative example embodiment may be augmented by an example embodiment, wherein the battery compartment 106 comprises a compartment groove 500, 502, 504, 506 capable of accommodating a compartment gasket of either the detachable cover 110 or the peripheral apparatus 130 to protect the battery 108 of the portable data processing apparatus 100 from at least one of moisture and dust, when the battery 108 and either the detachable cover 110 or the peripheral apparatus 130 is installed in place.

In an example embodiment, the battery compartment 106 comprises fasteners 512, 514, 516, 518, 520, 522, 524, 526, 528, 530, 532, 534, 536, 538, 540, 542 adapted and dimensioned such that they guide the positioning of the peripheral apparatus 130 during its installation, and secure the peripheral apparatus 130 in place after the installation.

FIG. 6 illustrates a further example embodiment of the peripheral apparatus 130. As shown, the peripheral apparatus 130 comprises counterpart fasteners 608, 610, 612, 614, 616, 618, 620, 622, 624, 626, 628, 630, 632, 634, 636, 638.

In an example embodiment the fasteners 512, 514, 516, 518, 520, 522, 524, 526, 528, 530, 532, 534, 536, 538, 540, 542 and the counterpart fasteners 608, 610, 612, 614, 616, 618, 620, 622, 624, 626, 628, 630, 632, 634, 636, 638 have a mechanical structure that interlocks as the peripheral apparatus 130 is pushed into the battery compartment 106. In an example embodiment they are made of plastic material.

Furthermore, the peripheral apparatus 130 may comprise pegs 640, 642, 644, 646 received by corresponding slots in the battery compartment 106.

FIG. 7 illustrates an example embodiment of fasteners attaching the peripheral apparatus 130 to the portable data processing apparatus 100: the counterpart fasteners 636, 638 snap around the fasteners 514, 516.

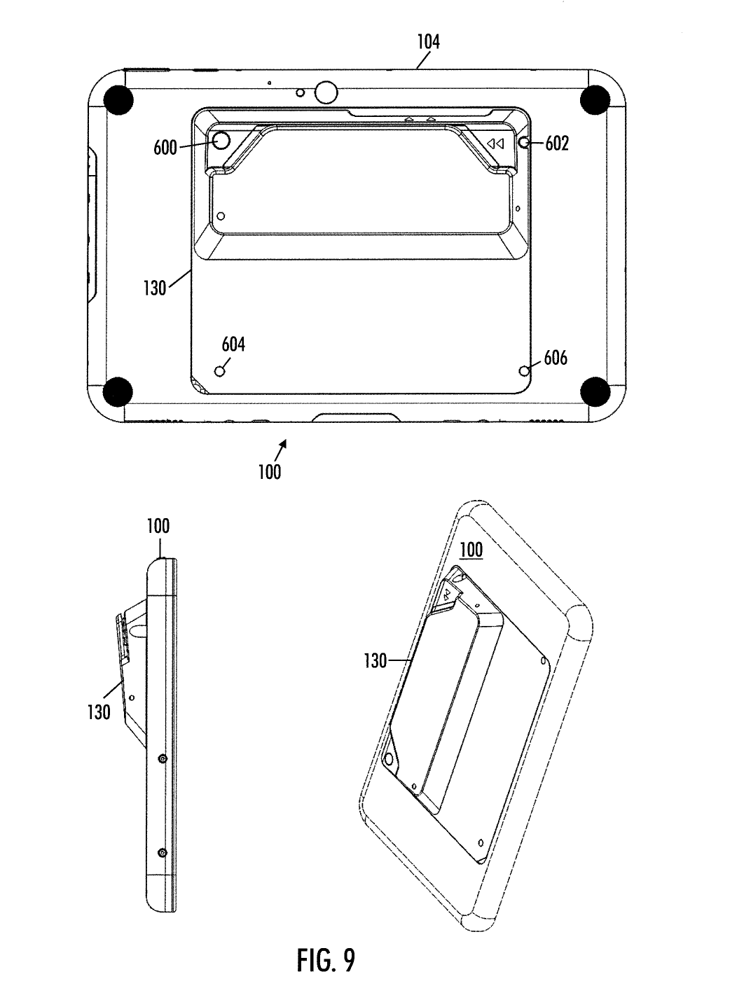

In an example embodiment, the battery compartment 106 comprises threads 550, 552, 554, 556 for mating with screws driven through the peripheral apparatus 130 in order to fix the peripheral apparatus 130 to the portable data processing apparatus 100. FIGS. 6 and 9 show that the peripheral apparatus 130 may have holes 600, 602, 604, 606 through which the screws may be driven.

In an example embodiment illustrated in FIGS. 3, 4 and 5, the battery compartment 106 comprises a battery fastener 310, 312 adapted and dimensioned to receive a counterpart fastener 660, 662 of either the detachable cover 110 or the peripheral apparatus 130 and clamp the battery 108 of the portable data processing apparatus 100 in place in the battery compartment 106. In an example embodiment, the battery 108 may comprise a recess into which the battery fastener 310, 312 is pushed by the counterpart fastener 660, 662.

In an example embodiment illustrated in FIG. 9, the peripheral apparatus 130 is adapted and dimensioned, when installed in place, to cover a portion of a backside of the housing 104. This provides a strong structure as the peripheral apparatus 130 does not project beyond the sides between the front and the backside of the portable data processing apparatus 100, but it only projects backwards.

In an example embodiment illustrated in FIGS. 5, 6 and 9, the electrical connector 112 is adapted and dimensioned to face outwards from an inside of the battery compartment 106 such that when the peripheral apparatus 130 is installed in place the electrical connector 112 is automatically communicatively coupled 142 with the electrical counterpart connector 132. In an example embodiment the electrical connector 112 faces outwards in a plane that is perpendicular to the backside of the portable data processing apparatus 100 and/or perpendicular to the recess 402 of the battery compartment 106 capable of accommodating the battery 108.

In an example embodiment illustrated in FIG. 5, the electrical connector 112 is adapted and dimensioned to leave the electrical connector 112 free to communicatively couple 142 with the electrical counterpart connector 132 when the battery 108 of the data processing apparatus 100 is installed in place in the battery compartment 106.

Next, let us study the electrical connector 112 in more detail with reference to FIG. 8 and Table 1.

In an example embodiment, the electrical connector 112 is adapted to operate at least partly according to a standard communication protocol, but the layout of the electrical connector 112 is adapted and dimensioned at least partly in a proprietary way.

In an example embodiment, the electrical connector 112 operates at least partly according to the universal serial bus USB communication protocol. USB is an industry standard defining the cables, connectors and communications protocols used in a bus for connection, communication, and power supply between computers and electronic devices.

In an example embodiment of FIG. 8, the electrical connector 112 comprises a plurality of pads 800, 802, 804, 806, 808, 810, 812, 814, 816, 818 capable of receiving pins 670, 672, 674, 676 (see also FIG. 6) of the counterpart connector 132. In an example embodiment, the pads may be positioned as shown, in a straight line, whereby the electrical connector 112 and the counterpart electrical connector 132 have a simple and robust mechanical structure. In an example embodiment the pads 800, 802, 804, 806, 808, 810, 812, 814, 816, 818 may be contact surface areas of a printed circuit board.

In an example embodiment, the electrical connector 112 comprises a plurality of pads 800, 802, 804, 806, 808, 810, 812, 814, 816, 818 implementing a standard communication protocol.

In an example embodiment, the electrical connector 112 comprises at least one pad capable of outputting electrical power to the peripheral apparatus 130. Consequently, the peripheral apparatus 130 does not necessary need a power source of its own as electric power from the portable data processing apparatus 100 is fed, for example from the battery 108.

In an example embodiment, the electrical connector 112 comprises at least one pad operating according to a proprietary communication protocol.

The use of the standard communication protocol simplifies the implementation of the required software 118 and also ensures a good compatibility. The use of the proprietary communication protocol enables easy addition of features if required.

In an example embodiment, the electrical interface between the portable data processing apparatus 100 and the peripheral apparatus 130 is defined as a custom connector 112 comprising ten contact pads and a counterpart connector 132 comprising one to ten pins 800, 802, 804, 806, 808, 810, 812, 814, 816, 818. Number of contacts at the peripheral apparatus 130 may be adjusted depending on the needed functionality. Table 1 describes an example embodiment of interface pins and their main functional groups.

TABLE 1
Interface pinout.

| Pin | | | | Func- |
|---|---|---|---|---|
| # | Name | Description | Voltage/Current | tion |
| 800 | USB_DP | USB 2.0 Data+ | USB standard | USB |
| 802 | USB_DN | USB 2.0 Data− | | |
| 804 | GND | Ground (for USB) | Ground | |
| 806 | VBUS | 5 V power supply | 4.75-5.25 V/ | |
| | | (or optional | 500 mA | |
| | | battery power | or | |
| | | supply) | 3.0-4.35 V/1 A | |
| 808 | GPIO | General purpose I/O | 1.8 V | Accessory |
| | | for accessory | | Control |
| | | control or | | |
| | | communication. | | |
| 810 | VIO_1V8 | I/O power supply | 1.8 V/300 mA | |
| | | 1.8 V | | |
| 812 | DCIN | DC input | 5-17 V/2 A | Tablet |
| | | | | Power |
| | | | | Supply |
| 814 | DCIN | | | |
| 816 | GND | Ground | Ground | |
| | | (for DC input) | | |
| 818 | GND | | | |

Electrical characteristics of the USB interface 800, 802, 804 meet the standard USB host device requirements. It supports USB Full Speed and USB High Speed interface standards. The portable data processing apparatus 100 may deliver up to 5V/500 mA power supply for the peripheral apparatus 130 through the VBUS pin 806. This means that all standard USB slave devices are electrically compliant and may be used as a part of the peripheral apparatus 130.

The physical interface 800, 802, 804 is custom and standard USB devices cannot be attached without a suitable adapter. The interface is designed so that USB signals are grouped allowing design of physical interface in a such way that signal integrity, EMI (electromagnetic interference) and EMC (electromagnetic compatibility) issues are taken into consideration.

VBUS power supply 806 may be controlled by software 118 or hardware to enable different powering schemes for the peripheral apparatus 130. In the default configuration, the peripheral apparatus 130 powering is hardware-controlled so that power is supplied when device is in active mode. Powering scheme is dependent on the tablet version and may not be end-user configurable. The portable data processing apparatus 100 has an option to change the VBUS connection as a direct connection to the tablet battery power, which allows more power to be supplied to the peripheral apparatus 130. This option is not in use in default configuration and is not according to the USB standard.

The accessory control may comprise two pins 808, 810, which may be used for various purposes. Use of accessory control interface is not limited for the purposes described below.

General purpose I/O pin 808 may be configured to work as a portable data processing apparatus 100 input, output or bi-directional.

An example use for an output pin is to use it to control power state of the peripheral apparatus 130 (power on/off, sleep) or to reset it. It may be used as the only interface towards the peripheral apparatus 130 if only simple communication is required or it can serve as a low power communication interface when USB is not powered.

GPIO pin 808 may be used as an interrupt or wake signal from the peripheral apparatus 130 to the portable data processing apparatus 100 in cases wherein the USB interface is not always active.

VIO_{—}1V8 810 is a 1.8V power supply, which is mainly targeted to be used as an I/O voltage for the peripheral apparatus 130, which is using GPIO interface. Having a 1.8V supplied from the portable data processing apparatus 100, the peripheral apparatus 130 does not need separate I/O voltage regulation.

VIO_{—}1V8 810 is only shut down when the peripheral apparatus 130 is fully powered off. This allows the use of 1.8V supply as a low power supply in case VBUS needs to be shut down but some low power operation needs to be active during that time.

Tablet power supply interface 812, 814, 816, 818 is targeted to be used for battery 108 charging of the portable data processing apparatus 100. Because of high power capability (up to 34 W), the portable data processing apparatus 100 may be powered from the power supply even without the battery 108.

It is to be noted that the above description with reference to Table 1 is just one example embodiment, i.e., the standard may be adapted, and also the pin configuration.

It will be obvious to a person skilled in the art that, as technology advances, the inventive concept can be implemented in various ways. The invention and its embodiments are not limited to the example embodiments described above but may vary within the scope of the claims.

1. A portable data processing apparatus comprising
a touch screen,
one or more processors communicatively coupled with the touch screen,
a housing holding the touch screen and encasing the one or more processors,
a battery compartment within the housing, and
a detachable cover for the battery compartment,
wherein the battery compartment comprises an electrical connector communicatively coupled with the one or more processors, and the battery compartment and the electrical connector are adapted and dimensioned such that the detachable cover is replaceable with a peripheral apparatus, which, when installed in place, functions as the cover of the battery compartment, and the one or more processors become communicatively coupled through the electrical connector with an electrical counterpart connector of the peripheral apparatus.

2. The portable data processing apparatus of claim 1, wherein the peripheral apparatus is adapted and dimensioned, when installed in place, to cover a portion of a backside of the housing.

3. The portable data processing apparatus of claim 1, wherein the electrical connector is adapted and dimensioned to face outwards from an inside of the battery compartment such that when the peripheral apparatus is installed in place the electrical connector is automatically communicatively coupled with the electrical counterpart connector.

4. The portable data processing apparatus of claim 1, wherein the electrical connector is adapted and dimensioned to leave the electrical connector free to communicatively couple with the electrical counterpart connector when a battery of the data processing apparatus is installed in place in the battery compartment.

5. The portable data processing apparatus of claim 1, wherein the electrical connector is protected by a detachable shield, which is removed before the peripheral apparatus is installed in place.

6. The portable data processing apparatus of claim 1, wherein the electrical connector is adapted to operate at least partly according to a standard communication protocol, but the layout of the electrical connector is adapted and dimensioned at least partly in a proprietary way.

7. The portable data processing apparatus of claim 1, wherein the electrical connector operates at least partly according to the universal serial bus communication protocol.

8. The portable data processing apparatus of claim 1, wherein the electrical connector comprises a plurality of pads capable of receiving pins of the counterpart connector.

9. The portable data processing apparatus of claim 1, wherein the electrical connector comprises a plurality of pads implementing a standard communication protocol.

10. The portable data processing apparatus of claim 1, wherein the electrical connector comprises at least one pad capable of outputting electrical power to the peripheral apparatus.

11. The portable data processing apparatus of claim 1, wherein the electrical connector comprises at least one pad operating according to a proprietary communication protocol.

12. The portable data processing apparatus of claim 1, wherein the battery compartment comprises a compartment groove capable of accommodating a compartment gasket of either the detachable cover or the peripheral apparatus to also protect the electrical connector from at least one of moisture and dust, when either the detachable cover or the peripheral apparatus is installed in place.

13. The portable data processing apparatus of claim 1, wherein the electrical connector comprises a connector groove capable of accommodating a connector gasket of either the detachable cover or the peripheral apparatus to protect the electrical connector from at least one of moisture and dust, when either the detachable cover or the peripheral apparatus is installed in place.

14. The portable data processing apparatus of claim 13, wherein the battery compartment comprises a compartment groove capable of accommodating a compartment gasket of either the detachable cover or the peripheral apparatus to protect a battery of the portable data processing apparatus from at least one of moisture and dust, when the battery and either the detachable cover or the peripheral apparatus is installed in place.

15. The portable data processing apparatus of claim 1, wherein the battery compartment comprises fasteners adapted and dimensioned such that they guide the positioning of the peripheral apparatus during its installation, and secure the peripheral apparatus in place after the installation.

16. The portable data processing apparatus of claim 1, wherein the battery compartment comprises threads for mating with screws driven through the peripheral apparatus in order to fix the peripheral apparatus to the portable data processing apparatus.

17. The portable data processing apparatus of claim 1, wherein the battery compartment comprises a battery fastener adapted and dimensioned to receive a counterpart fastener of either the detachable cover or the peripheral apparatus and clamp a battery of the portable data processing apparatus in place in the battery compartment.

18. The portable data processing apparatus of claim 1, wherein the portable data processing apparatus comprises a tablet computer.

19. A peripheral apparatus for a portable data processing apparatus, comprising
an electronics module,
a unit housing encasing the electronics module,
an electrical counterpart connector communicatively coupled with the electronics module,
wherein the peripheral apparatus and the electrical counterpart connector are adapted and dimensioned such that a cover of a battery compartment of the portable data processing apparatus is replaceable with the peripheral apparatus, which, when installed in place, functions as the cover of the battery compartment, and the electrical counterpart connector of the peripheral apparatus is communicatively coupled with one or more processors of the portable data processing apparatus through an electrical connector of the portable data processing apparatus.

20. A combination of a portable data processing apparatus and a peripheral apparatus,
the portable data processing apparatus comprising
a touch screen,
one or more processors communicatively coupled with the touch screen,
a housing holding the display and encasing the one or more processors,
a battery compartment within the housing,
a detachable cover for the battery compartment mechanically couplable with the housing,
wherein the battery compartment comprises an electrical connector communicatively coupled with the one or more processors, and the battery compartment and the electrical connector are adapted and dimensioned such that the detachable cover is replaceable with the peripheral apparatus, which, when installed in place, functions as the cover of the battery compartment, and the one or more processors become communicatively coupled through the electrical connector with an electrical counterpart connector of the peripheral apparatus,
the peripheral apparatus comprising
an electronics module,
a unit housing encasing the electronics module,
an electrical counterpart connector communicatively coupled with the electronics module,
wherein the peripheral apparatus and the electrical counterpart connector are adapted and dimensioned such that the cover of the battery compartment is replaceable with the peripheral apparatus, which, when installed in place, functions as the cover of the battery compartment, and the electrical counterpart connector of the peripheral apparatus is communicatively coupled with the one or more processors through the electrical connector.
